(19) United States
(12) Patent Application Publication
(10) Pub. No.: US 2009/0034509 A1
(43) Pub. Date: Feb. 5, 2009

(54) METHOD AND SYSTEM FOR REDUCING UPSTREAM NOISE IN A NETWORK USING AN ACTIVE MULTIPLEXER

(76) Inventors: Steven Krapp, Naperville, IL (US); Tom Cloonan, Lisle, IL (US); Todd Kessler, Naperville, IL (US)

Correspondence Address: ARRIS INTERNATIONAL, INC, 3871 LAKEFIELD DRIVE, SUWANEE, GA, 30024, US

(21) Appl. No.: 11/830,716

(22) Filed: Jul. 30, 2007

(51) Int. Cl. H04L 12/66

(52) U.S. Cl. 370/352

(57) ABSTRACT

An active multiplexer contains a switching mechanism that connects one of a plurality of upstream links from corresponding nodes in a communication network to an upstream output based on information contained in a MAP. The MAP contains scheduling information of the next user stations, which are coupled to the nodes, and which are scheduled to transmit in the upstream direction during a period following the current time. Station identifiers are associated with their corresponding node identifier during a ranging burst interval into a station/node table, which is used in conjunction with the MAP to control the active multiplexer. Based on the MAP, the active multiplexer connects the node, as determined from the station/node table, that serves the station that is scheduled to transmit upstream traffic and disconnects other nodes.

### CROSS REFERENCE TO RELATED APPLICATION

This application claims priority under 35 U.S.C. 119(e) to Krapp, et. al., entitled “Method and system for intelligently multiplexing data signals for transmission over an electrical power network,” having a filing date Jul. 28, 2006, and which is incorporated by reference herein in its entirety.

### FIELD OF THE INVENTION

This invention relates, generally, to communication networks and, more particularly, to reducing noise in a multiple station, multiple node environment.

### BACKGROUND

FIG. 1 illustrates communication network equipment 2 having a passive multiplexer 4 that couples to a burst receiver 6. Communication network 2, may be, for example, a hybrid fiber coaxial cable network (“HFC”), a broadband over power lines network (“BPL”), a digital subscriber line network (“DSL”), or other communication network. Multiplexer 4 may receive upstream traffic signals from nodes, which include analog to digital converters (A/D) 8 A-n when network 2 is an HFC network. The symbols on the right side of A/D converters 8 in the figure indicate that the signal coming into and out of the converter on the right side (upstream and downstream respectively) is an analog signal. The sequence of 1s and 0s to the left of each A/D converter 8 indicates that the upstream signal exiting and entering (upstream and downstream, respectively) the converters is digital. Converters 8 receive upstream traffic from stations 10, which may be cable modems in an HFC environment.

When multiple nodes having corresponding A/D converters are connected to the multiplexer 4, and the multiplexer is a passive multiplexer, noise from each of the links 12 add together to create an unacceptable noise level at central equipment 13, which typically includes cable modem termination system equipment when network 2 is an HFC network. If more than four nodes are coupled to multiplexer 4, the noise level at CMTS 13 may be unacceptable. For purposes of discussion, the upstream direction refers to traffic flowing in the direction from a user station toward the CMTS. Downstream refers to traffic flowing in the direction from the CMTS towards user stations.

### BRIEF DESCRIPTION OF THE DRAWINGS

FIG. 1 illustrates a passive multiplexer used in a communication network.

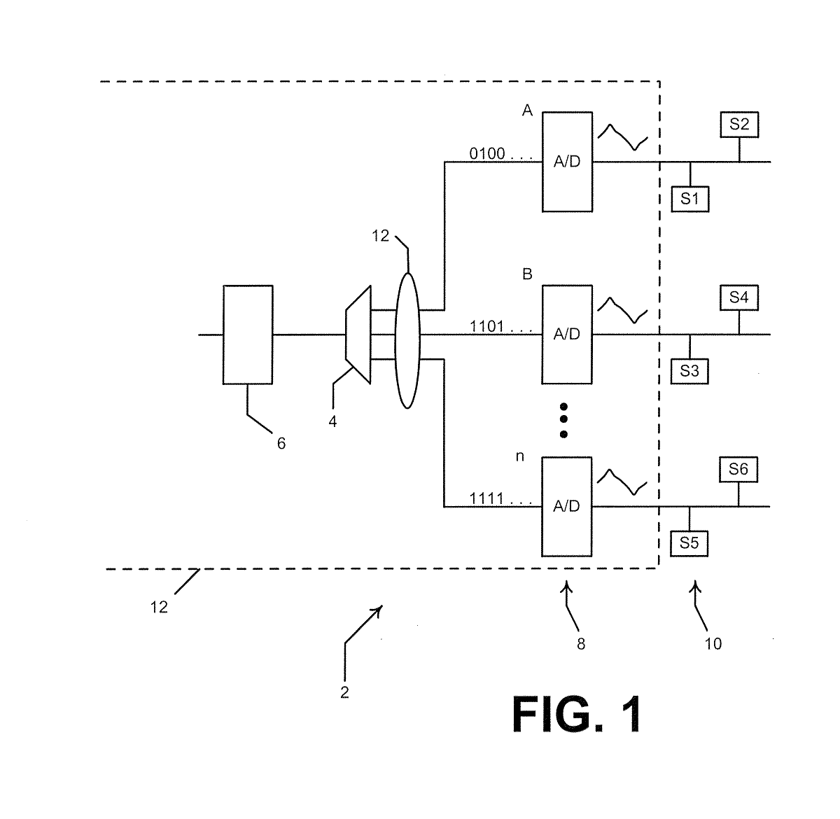

FIG. 2 illustrates an active multiplexer used in a communication network.

FIG. 3 illustrates a flow diagram of a method for using an active multiplexer in a communication network.

FIG. 4 illustrates an internal schematic of an active multiplexer used in a BPL communication network.

FIG. 5 illustrates an active multiplexer used in a BPL network.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. The following disclosure is not intended nor is to be construed to limit the present invention or otherwise to exclude any such other embodiments, adaptations, variations, modifications and equivalent arrangements, the present invention being limited only by the claims appended hereto and the equivalents thereof.

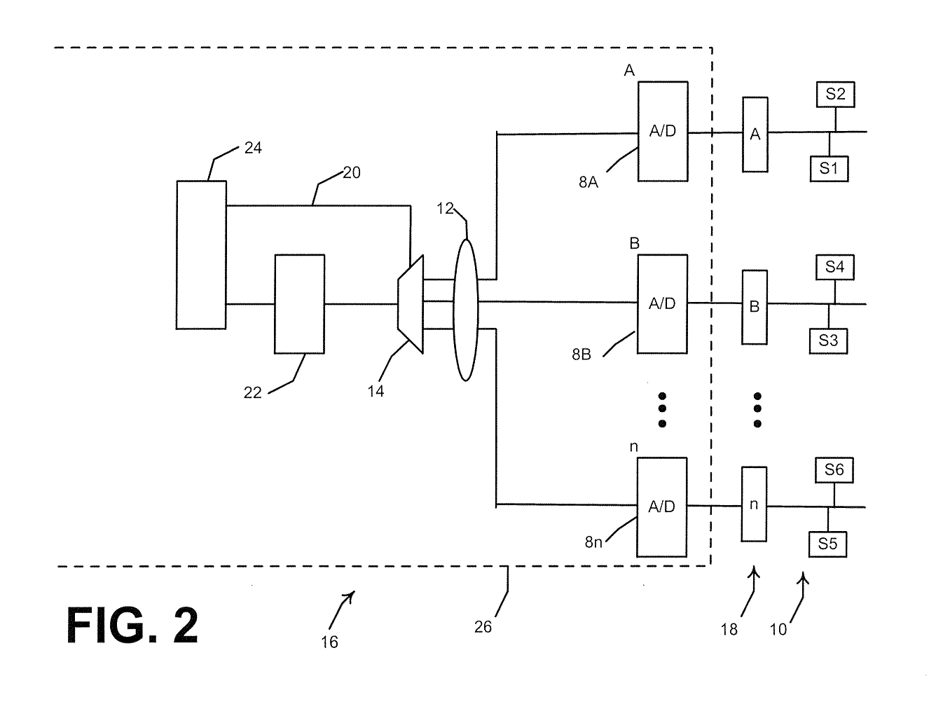

Turning now to the figures, FIG. 2 illustrates an active multiplexer 14 used in a communication network 16. Nodes 18A-n transmit upstream traffic to A/D converters 8A-n, which send their respective upstream digitally-encoded signals to converter active multiplexer 14 over links 12. Links 12 typically can carry digitally-encoded information signals over an optical network, or the links could also carry signals over coaxial cable, twisted pair, or other transmission media known in the art. Active multiplexer 14 is an active multiplexer that has switching capabilities. A control signal over control link 20 causes the switching mechanism inside multiplexer 14 to connect one of links 12A-n to burst receiver 22. The control signal sent to multiplexer 14 is generated at central scheduler 24.

Central scheduler 24 bases the control signal on input from other portions of CMTS 26, which is depicted in the figure with broken lines. CMTS 26 is depicted with broken lines to indicate that central scheduler 24 may be located remotely from the CMTS, or located in the same chassis as CMTS Cable Access Modules (“CAM”), which are known in the art for interfacing traffic signals from a communication network. In addition, A/D converters 18 are typically located at CMTS 26, but could also be located at remote nodes 18. MAP messages, as known in the art related to cable modem communication systems, contain schedule information that is sent downstream from scheduler 24 to stations 10. Multiple stations 10 are coupled to each node 18. According to the Data Over Cable System Interface Specification (“DOCSIS”), as known in the art, upstream communication between cable modems and CMTSs are scheduled according to the MAP in a MAP message.

Traffic from stations corresponding to any given node 18, and any given station 10 coupled to a given node for that matter, transmit upstream towards the CMTS exclusive of any other upstream transmission from any other station or node. The MAP can be used to cause the switching mechanism internal to active multiplexer 14 to only connect the link 12 corresponding to the node that is transmitting upstream traffic at a particular time. Thus, since only one link 12 is connected to burst receiver 22 at any given time, only noise from the connected link is received at the burst receiver. Accordingly, the signal to noise ratio for the system is always the same as the link 12 and corresponding node 18 and stations 10 that is/are currently connected by active multiplexer 14.

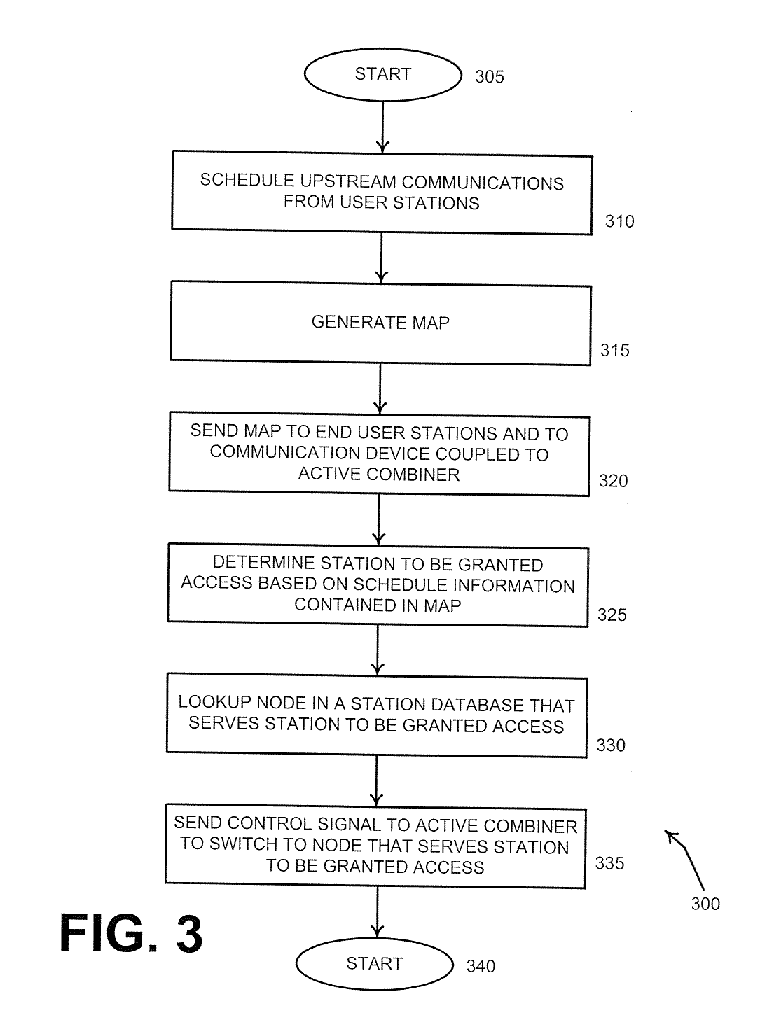

Turning now to FIG. 3, the figure illustrates a flow diagram of a method 300 for using an active multiplexer in a communication network. Method 300 starts at step 305. At step 310, upstream communication opportunities from a plurality of user stations, for example cable modems, are scheduled according to various criteria, such as quality of service, type of information being communicated, time since last transmission, etc. Scheduling of upstream transmissions typically takes place at a CMTS device; more particularly, a scheduling device coupled to the CMTS. However, the scheduling device may also be integrated with the CMTS. The scheduling Information is formed into a MAP, which is generated at step 315. The MAP is sent as a message at step 320 toward cable modems and other devices, such as set top boxes for example, that may be requesting a grant of upstream bandwidth by the CMTS. The cable modems and other devices use information contained in the MAP to coordinate the transmitting of upstream information toward the CMTS.

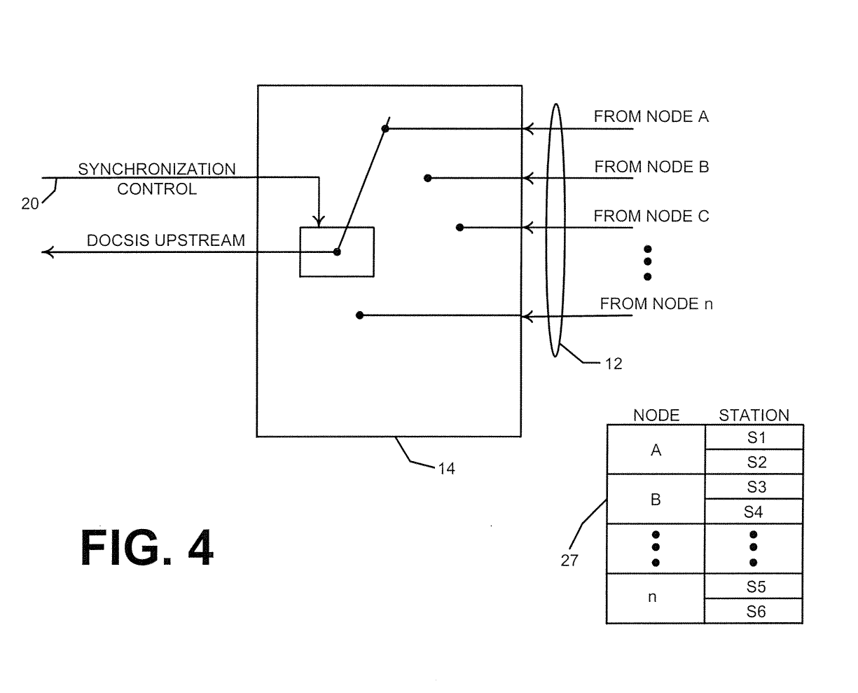

In addition to user station devices, such as cable modems at subscriber's homes or offices, a multiplexer cable modem device is located at, or near, the active multiplexer. The multiplexer cable modem also receives every MAP message that is sent at step 320. The active multiplexer, or the multiplexer cable modem associated with the active multiplexer, uses the MAP to determine which cable modems are to transmit at a given time. A station/node table 27 (shown in FIG. 4) associating user stations with nodes, and preferably indexed by user station, is queried to determine which node the next modem that is scheduled to transmit (presently scheduled modem) is coupled to. This determination is based on the next cable modem to transmit according to the MAP. It will be appreciated that the algorithm that determines the scheduling of devices in the MAP may operate according to standard traffic engineering practices and the service levels of the various cable modems. However, the scheduling device may also base the scheduling of user station devices and the nodes that provide service thereto on a predetermined scheduling of node connections by the active multiplexer.

Regardless of the algorithm used by the scheduling device, a control signal is sent to the active multiplexer at step 335 instructing the multiplexer to switch its internal switching mechanism to connect the node that serves the next user station that will be transmitting to a burst receiver at the head end, typically collocated with the CMTS. When the active multiplexer switches to connect the node that serves the next cable modem to transmit at step 335, the other nodes are typically disconnected. Only one node, and its associated cabling, amplifiers, connectors, etc., are physically connected to the burst receiver at a given time. Thus, only noise is introduced to burst receiver from only one leg of the network, such as an HFC, for example. The process ends at step 340. For each change of user station scheduled to transmit, an iteration of method 300 takes place. If the next user station to transmit is served by the same node as is currently connected through the active multiplexer, the active multiplexer does not have to change the position of its internal switching mechanism. If the next station to transmit upstream is a served by a different node than the currently connected node, the internal switching mechanism changes to connect the next node and disconnect the others.

It will be appreciated that the switching mechanism is preferably an electronic switch, such as an integrated circuit, rather than a mechanical switch. While analogy to a mechanical switch may make sense to describe and understand how the active multiplexer works and what it does, a mechanical switching device may be slower than an electronic switch, requiring longer guard-bands between successive transmissions. Changes in stations scheduled to transmit upstream can occur as often as a matter of milliseconds. Thus, electronic digital switching techniques are typically preferable.

Nevertheless, it will also be appreciated that the switching mechanism could be performed in the analog domain instead of in the digital domain. In this instantiation, the switching mechanism would likely have to be a mechanical switch that steers the active analog signal to a combiner (in place of the active multiplexer), and the output of the combiner would contain only the analog feed from the active node. The requisite A/D conversion of the signals would then occur between the combiner and the burst receiver.

Turning now to FIG. 4, active multiplexer 14 is schematically illustrated as a multi-way mechanical switch, although it will be appreciated that the conductor paths through the switch are preferably implemented in integrated circuit devices, or equivalent. Each of paths 12A-n couple to corresponding nodes A/D converters as shown in FIG, 2. Since the CMTS ‘knows’ which modem is scheduled to transmit upstream next, a station/node table 27 is used to determine the node that should be connected by multiplexer 14 to facilitate the next upstream transmission. Table 27 may be stored locally with respect to the active multiplexer 14 on a storage device, such as a hard disk, a flash memory, RAM, or the like, that the multiplexer, or a processor coupled thereto, can access. The station/lookup table can also be stored at a storage device located at the CMTS.

Data in the station/node table 27 is populated into the table. To ascertain which node a particular station is attached to, system 16 may use one of several methods. One preferred technique capitalizes on the fact that every end station (ex; a cable modem in an HFC network) ranges and registers with the CMTS prior to being permitted to operate. Ranging is the process by which the end station first communicates with the CMTS. The CMTS identifies specific burst intervals of time (known as ranging burst intervals) during which newly-arrived end stations can attempt to communicate in the upstream direction with the CMTS. If the CMTS specifies that the setting of the active multiplexer 14 permits one and only one feed from only one permitted node to be connected to the burst receiver during each ranging burst interval, then the CMTS can determine which node a particular end station is attached to by examining the settings of the active multiplexer when the particular end station successfully ranged with the CMTS. This knowledge combined with information that uniquely identifies the station that is currently ranging is then be used to populate the station/node table. The instruction can be sent from the CMTS to the actice multiplexer 14 using signal line 20 shown in FIG. 2.

After table 27 has been populated, either the MAP itself, or the result of the table look-up, is sent from the CMTS scheduler via control line 20 to cause the ‘switch’ mechanism inside the multiplexer to connect to the switch ‘contact’ corresponding to the node which is coupled to the station that is to transmit. In the case of a cable modem and processing being collocated at the active multiplexer, which may be remote from the CMTS, the MAP itself may be processed locally (with respect to the multiplexer) and the station/node table can be located locally (with respect to active multiplexer 14) too. Alternatively, the MAP processing and/or station/node table look up may be processed remotely with respect to active multiplexer 14, and an instruction as to which node to connect may be all that is sent to the multiplexer. For example, a message may be sent to multiplexer 14 having the address of the desired node to connect in the message. When the active multiplexer 14, or cable modem collocated thereby, receives and processes the instruction, digital switches located in multiplexer 14 make up the path corresponding to the node contained in the message. In the example shown in the figure, the switch mechanism is shown connecting node A to the DOCSIS upstream link.

In an alternative embedment, relays may be located at nodes 18 shown in FIG. 2, and control signals may be sent to the nodes instructing them to couple or decouple from the network of upstream links sending communication signals toward the CMTS. The relays would preferable comprise high-speed digital switching devices, such as integrated circuits, for example.

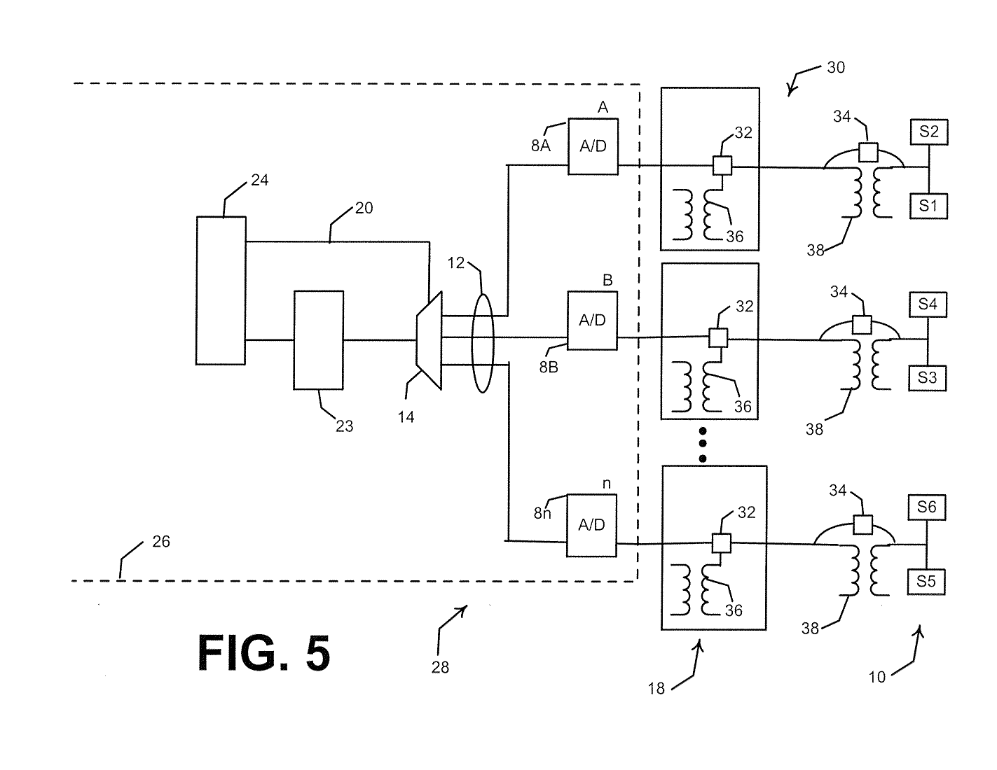

Turning now to FIG. 5, an alternative embodiment is shown. A system 28 delivers broadband signals over an electrical power distribution network 30 and upstream signals from the electrical network toward the CMTS 26 are combined using active multiplexer 14 as discussed above. Analog signals to/from power distribution network 30 interface using broadband over power fines (“BPL”) interface devices, such as for example, CT couplers. Couplers 32 are used at nodes 18 and couplers 34 are used at near the customer's premises. Couplers 32 are used at nodes 18 to bypass distribution transformers 36 and couplers 34 are used near the customer's/subscriber's premises to bypass step-down transformers 38. It will be appreciated that couplers 34 typically include a coupler and a bridge device as known in the art. Thus, distribution couplers 32 and step-down couplers 34 provide a route for communication signals to bypass the corresponding distribution transformers 36 and step-down transformers 38, respectively.

Although couplers 32 and 34 provide a bypass around transformers 36 and 38, noise in the upstream direction would still be cumulative if instead of active multiplexer 14 a passive multiplexer were used. Thus, by providing a control signal along control link 20, multiplexer 14 connects only the station or stations, and corresponding node and relates circuitry, to burst receiver 23.

These and many other objects and advantages will be readily apparent to one skilled in the art from the foregoing specification when read in conjunction with the appended drawings. It is to be understood that the embodiments herein illustrated are examples only, and that the scope of the invention is to be defined by the claims when accorded a full range of equivalents.

What is claimed is:

1. A system for reducing noise in a communication network, comprising;
multiple upstream links;
a scheduler;
an active multiplexer, the active multiplexer including:
multiple upstream inputs for coupling to corresponding links of the multiple upstream links;
a control signal input for receiving a control signal from a control signal link; and
a switching mechanism for making a connection between one of the upstream inputs and the upstream output in response to a control signal received from the scheduler at the control signal input.

2. The system of claim 1 wherein the scheduler is part of a CMTS.

3. The system of claim 1 wherein the upstream links couple upstream inputs with corresponding A/D converters.

4. The system of claim 3 wherein the A/D converters are located at nodes, which are located remotely from a CMTS that includes scheduler and the active multiplexer.

5. The system of claim 3 wherein the A/D converters, scheduler and active multiplexer are located at a CMTS.

6. The system of claim 1 wherein the scheduler is a MAP scheduler of a CMTS.

7. The system of claim 1 wherein the multiple upstream inputs are optical inputs.

8. The system of claim 1 wherein the multiple upstream inputs are electrical inputs.

9. The system of claim 1 further comprising an upstream output that couples to a receiver at a CMTS.

10. The system of claim 9 wherein the receiver is a burst receiver.

11. The system of claim 1 wherein the switching mechanism includes integrated circuit switches.

12. The system of claim 1 wherein the switching mechanism includes discrete electronic switching devices.

13. The system of claim 1 wherein the discrete electronic switching devices include transistors.

14. The system of claim 1 wherein the active multiplexer includes a processor for receiving the control signal from the control signal input and generating a signal that causes the switching mechanism to make the connection as instructed by information contained in the control signal.

15. The system of claim 14 wherein a cable modem is collocated with the active multiplexer for receiving a control signal from a CMTS, the cable modem processing the control signal and providing the processed control signal to the control signal input.

16. The system of claim 1 wherein a station/node lookup table is stored locally with respect to the active multiplexer.

17. The system of claim 1 wherein a station/node lookup table is stored remotely with respect to the active multiplexer.

18. A method for reducing noise in a communication network, comprising:
receiving a schedule of upstream communication opportunities in a message;
determining a node that corresponds to a station presently scheduled to transmit according to the schedule of upstream communication opportunities; and
causing a switching mechanism to connect the node corresponding to the station presently scheduled to transmit.

19. The method of claim 18 further comprising generating the schedule of upstream communication opportunities and transmitting the schedule toward the user stations.

20. The method of claim 18 wherein the node that corresponds to the station presently scheduled to transmit is determined by performing a lookup of a station/node table based on information in the schedule.

21. The method of claim 18 wherein the schedule is a MAP.

22. The method of claim 18 wherein the schedule is contained in a MAP message.

23. An active multiplexer, comprising:
multiple upstream inputs for coupling to corresponding links of multiple communication nodes;
a control signal input for receiving a control signal from a control signal link; and
a switching mechanism for making a connection between one of the upstream inputs and the upstream output in response to a control signal received from a scheduler at the control signal input, wherein the control signal includes information regarding which of the multiple communication nodes corresponds to a user station presently scheduled to transmit upstream.

24. The active multiplexer of claim 23 wherein the control signal is generated based on a MAP.

25. The active multiplexer of claim 23 wherein the switching mechanism includes an integrated circuit.

26. A method to populate a station/node table, comprising:
permitting only a permitted node to allow upstream transmission to a CMTS during a given ranging burst interval;
associating a unique identifier from a station that transmits during the ranging burst interval with a node identifier corresponding to the permitted node; and
storing the station's unique identifier into a station/node table so that the station's unique identifier is associated with the corresponding node identifier in the station/node table.
